(19) United States
(12) Patent Application Publication
(10) Pub. No.: US 2022/0043287 A1
(43) Pub. Date: Feb. 10, 2022

(54) Switchable Raman Nath Gratings

(71) Applicant: DigiLens Inc., Sunnyvale, CA (US)

(72) Inventors: Alastair John Grant, San Jose, CA (US); Sihui He, Sunnyvale, CA (US); Hyesog Lee, Sunnyvale, CA (US); Milan Momcilo Popovich, Leicester (GB)

(73) Assignee: DigiLens Inc., Sunnyvale, CA (US)

(21) Appl. No.: 17/398,936

(22) Filed: Aug. 10, 2021

Related U.S. Application Data
(60) Provisional application No. 63/063,921, filed on Aug. 10, 2020.

(51) Int. Cl. G02F 1/01; G02B 27/48; G02F 1/137

(52) U.S. Cl. CPC G02F 1/0136; G02F 1/137; G02F 1/011; G02B 27/48

(57) ABSTRACT

Disclosed herein is a switchable Raman Nath grating configured to be implemented in a waveguide-based display. The waveguide-based display may include: a waveguide; a light source; a coupler for directing light from the light source into a total internal reflection path within the waveguide; a switchable Raman-Nath grating supported by said waveguide operative to provide a first polarization direction sensitivity under a first voltage and a second polarization direction sensitivity under a second voltage; a voltage generator for applying a first voltage or a second voltage across the switchable Raman-Nath grating, where the switchable Raman-Nath grating receives light in the total internal reflection path. Switchable Raman-Nath gratings may provide advantageous effects which may make them particularly suitable for despeckler gratings.

### CROSS-REFERENCED APPLICATIONS

This application claims priority to U.S. Provisional Application 63/063,921 entitled “Reverse Mode Switchable Raman Nath Gratings” and filed on Aug. 10, 2020, the disclosure of which is incorporated herein by reference in its entirety.

### FIELD OF THE INVENTION

The present invention generally relates to switchable gratings and, more specifically, to reverse mode switchable Raman-Nath gratings.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE DISCLOSURE

Many embodiments are directed to a waveguide device including: a waveguide; a light source; a coupler for directing light from the light source into a total internal reflection path within the waveguide; a switchable Raman-Nath grating supported by the waveguide operative to provide a first polarization direction sensitivity under a first voltage and a second polarization direction sensitivity under a second voltage; and a voltage generator for applying the first voltage or the second voltage across the switchable Raman-Nath grating, wherein the switchable Raman-Nath grating receives light from the light in the total internal reflection path.

In various other embodiments, the switchable Raman-Nath grating includes fringes slanted with respect to an extending direction of waveguide.

In still various other embodiments, the switchable Raman-Nath grating is a despeckler grating.

In still various other embodiments, the switchable Raman-Nath grating includes an array of separately switchable elements.

In still various other embodiments, the switchable Raman-Nath grating includes

$$Q = \frac{2 π λ d}{{n}_{0} {Λ}^{2}} \leq 1 ,$$

a Q which satisfies the following equation: and d is the thickness of the switchable Raman-Nath grating, ∧ is the switchable Raman-Nath grating period, no is the average refractive index of the switchable Raman-Nath grating, and λ is the wavelength of the light in the total internal reflection path incident on the switchable Raman-Nath grating.

In still various other embodiments, the thickness d of the switchable Raman-Nath grating is between 0.5 to 3 microns.

In still various other embodiments, λ is between 400 nm to 700 nm.

In still various other embodiments, λ is between 750 nm to 2000 nm.

In still various other embodiments, the switchable Raman-Nath grating includes

$${Q}^{′} = \frac{Q}{cos ( θ )} \leq 1 ,$$

a Q′ which satisfies the following equation: and θ is the incidence angle of the light in the total internal reflection path incident on the switchable Raman-Nath grating.

In still various other embodiments, the switchable Raman-Nath grating includes chirped grating fringes.

In still various other embodiments, the switchable Raman-Nath grating includes a multiplexed grating.

In still various other embodiments, the switchable Raman-Nath grating includes slanted grating fringes and the waveguide further includes an alignment layer.

In still various other embodiments, the waveguide device provides input illumination to a waveguide display.

In still various other embodiments, the waveguide devices is configured to illuminate a reflection flat panel display and to provide a transmission path for light reflected from the reflection flat panel display.

In still various other embodiments, the switchable Raman-Nath grating includes a switchable grating formed from a material system including at least one monomer and at least one liquid crystal and provides an extraordinary refractive index axis parallel to the grating K-vector.

In still various other embodiments, the switchable Raman-Nath grating includes a reverse mode switchable grating.

In still various other embodiments, the switchable Raman-Nath grating is switchable such that the angle between the K-vector of the unswitched Raman-Nath grating and the K-vector of the switched Raman-Nath grating is between 34° to 90°.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIGS. 1A and 1B illustrate a conceptual schematic for a waveguide including a despeckler grating.

FIGS. 2A and 2B illustrate a conceptual schematic for a waveguide including a despeckler grating with a certain orientation in accordance with an embodiment of the invention.

FIGS. 3A and 3B illustrate a conceptual schematic for a waveguide including a despeckler grating with a certain orientation in accordance with an embodiment of the invention.

FIG. 4 illustrates a schematic of the grating of FIGS. 3A and 3B in accordance with an embodiment of the invention.

### DETAILED DESCRIPTION

Various embodiments of the invention relate to a waveguide display. The waveguide display may include a switchable grating. The switchable grating may be a switchable Raman-Nath grating. The switchable grating may be used as a waveguide despeckler which is a solid state device which despeckles laser beams for use in projection displays which may be used as projectors for Augmented Reality (AR) applications. In some embodiments, the AR projectors may be laser pico-projectors with despeckling technology in near-to-eye waveguide displays or in large scale heads-up displays (e.g. automotive heads-up displays) waveguide-based displays. This compact projector format may also benefit from projectors used without waveguide-based displays. Examples of AR projectors which a waveguide despeckler may be applicable are discussed in U.S. Pat. Pub. No. 20200264378 filed on Feb. 18, 2020 and entitled “Methods and Apparatuses for Providing a Holographic Waveguide Display Using Integrated Gratings” which is hereby incorporated by reference in its entirety.

Specifically, the technology aims to reduce objective speckle contrast, e.g. aims to smooth out speckle in the projection part of the display system. Objective speckle may arise from scattering off surfaces in the projection optical system. This contrasts with subjective speckle which may be in view when light from the projector is scattered by a rough surface such as a projection screen. The speckle grain size and other features of subjective speckle may depend on the aperture and other parameter of apparatus (e.g. human eye or camera) used to view the screen.

In some embodiments, the waveguide despeckler may be a solid state switchable pixelated switchable grating structure, in which the subset of grating pixels that are in their diffracting state changes temporally. Without limiting to any particular theory, the despeckler technology may work in the following manner: As light in the waveguide in total internal reflection (TIR) propagates through the despeckler gratings, the gratings may be switched between non-diffracting and diffracting (cleared and uncleared) states. Light interacts with different pixels either switched, or not switched at different points along the despeckler grating. As the despeckler grating switches between cleared and uncleared states, different phase and angular properties may be imparted to the propagating light. For a given static state of the despeckler waveguide, the light may have a certain divergence and phase properties which leads to a given speckle pattern in the final image. Summation of the set of speckle patterns corresponding to a multiplicity of such states can result in an averaging out of the speckle observed when light is extracted from the waveguide.

Originally, switchable Bragg gratings, e.g. gratings which operated in a Bragg or ‘thick’ grating regime were contemplated. This is a region where light substantially diffracts from an incident beam into a single diffracted order. Higher order diffraction effects are generally small, meaning that only a few percent of light diffract into order magnitudes greater than 1.

In some embodiments, the despeckler grating may include:
A diffusion function providing an average angular divergence of a few degrees where the zero order path corresponding to the incident beam and diffracted (diffused) beams may be substantially undeviated. This may ensure that light leaving the despeckler may be well aligned with the central TIR ray of an output grating which may maintain uniformity and efficiency in the output grating. In some embodiments the output grating may be a switchable Bragg grating.
A grating prescription for maintaining the polarization of the incident after diffraction. Clocked gratings may not be used as these would produce a diffracted beam polarization differing from that of the incident beam.

In some embodiments, the despeckler grating may be designed with a few degrees of diffusion angular spread e.g. approximately +/−3 deg in glass (n=1.51) at 56 deg central ray angle. At this angle the holographic grating may be a multiplexed grating (MUX) of the diffusion function centered on 56°. Approximately, the period of the MUX grating may be greater than or equal to about 6 micrometers (μm). In some embodiments, the average period may be about 12 μm. In some embodiments, the despeckler grating may have a thickness of about 3 microns. In some embodiments the despeckler grating may be a little thinner or thicker than 3 microns depending on switch voltage requirements (Volts/μm) and available modulation of refractive index which may determine the diffraction efficiency of the despeckler grating.

At approximately 12 μm periods, the despeckler grating using metrics defined below may no longer be in the thick (Bragg) grating regime. The despeckler grating at this period, may be considered in a thin (Raman-Nath) grating regime. Thus, the angular response and diffraction efficiency of the despeckler grating may be calculated based on a thin grating and simple unslanted Raman-Nath (RN) diffraction efficiency response profile. A RN grating diffracts incident beams into multiple diffraction orders over a wide angular range with the diffraction efficiency diminishing with increasing order. Bragg grating diffract light with high efficiency into a single order over a narrower angular range that depends on the grating thickness, modulation and other parameters. In some embodiments, the broad angular range of an RN may mean that the RN grating does not need to be designed for an ‘on-Bragg’ slant angle as would be the case in a thick grating where a strong diffraction response within a specified angular bandwidth may be desired.

In some embodiments, the RN grating may be produced by holographic exposure of a holographic recording mixture. The holographic recording mixture can include liquid crystal (LC) and monomer. In many such embodiments, after holographic exposure, the grating forms alternating polymer-rich and LC-rich fringes. The liquid crystal and polymer may phase separate to form LC domains with LC molecules having extraordinary axes (ne) aligned perpendicularly to the grating fringes, i.e. along the K-vector of the grating, such the grating is in a diffracting state with no voltage applied across the grating and is cleared when a voltage is applied. In some embodiments, the holographic recording mixture can comprise monomer and LC components for providing a grating in which the LC domains may be aligned perpendicularly to the grating vector. Such gratings are often referred to as reverse-mode HPDLC gratings. Such gratings are in a non-diffracting state with no voltage applied across the grating and become diffracting when a voltage is applied. Examples of holographic exposure of a holographic recording mixture to form a grating are discussed in U.S. Pat. Pub. No. 2021/0063634, filed on Aug. 28, 2020 and titled “Evacuating Bragg Gratings and Methods of Manufacturing” which is hereby incorporated by reference in its entirety. As a consequence of the preferred alignment of the LC along the K-vector, a slant angle may be selected to maximally align the slant angle of the grating such that the k-vector of the grating can be aligned at substantially equal angles to the upward and downward going TIR rays (which may subtend an angle equal to twice the TIR angle to each other). In some embodiments, the ne axis of the liquid crystal (LC) in the grating may be aligned to the incoming ray. The p-polarized electric field may not be coupled with the orthogonal ne axis of the LC, and instead derives modulation of refractive index from the difference between the LC ne axis and polymer indices. When these are index matched, the modulation of refractive index is zero which may give no diffraction from the despeckler grating.

When a voltage is applied across the grating by applying an E field to the ITO coated layers on either side of the grating film, the ne axis of the LC aligns along the applied electric field. Now the E-field of the ray may see a large component of the ne axis, and experience high modulation of refractive index, and hence may cause diffraction. In some embodiments. diffraction may have a Raman Nath diffraction characteristic according to various criteria to be discussed below.

In the reverse mode, the despeckler grating may cause diffraction when the voltage is applied across the ITO conductive film layers. When the voltage is removed, the diffraction of despeckler grating effectively clears. In some embodiments, the despeckler grating may include a single TIR interaction e.g. a ray interaction from only one side of the grating. Interactions may occur from the TIR ray from both sides of the despeckler grating. In some embodiments, up and down bouncing TIR interactions are balanced to have the same diffraction efficiency (DE) response by having the RN grating formed with unslanted fringes, e.g. the k-vector of the grating is orthogonal to the waveguide surface normal. Advantageously, Raman-Nath gratings (gratings that primarily rely on the Raman-Nath diffraction) have less angular dependence than typical Bragg gratings (gratings that primarily rely on Bragg diffraction). Thus, Raman-Nath gratings may have substantially equal DE for the up and down bouncing TIR rays that interact with the grating. More description of Raman-Nath gratings is provided below.

In some embodiments the switching operation may be applying a voltage to clear the grating and the absence of voltage to experience diffraction. In some embodiments, a reverse mode grating may be present where voltage is applied to experience diffraction and removal of applied voltage leading the grating clearance. In some embodiments, the despeckler grating may be a reverse mode switchable Raman-Nath (RMSRN) grating.

### Comparison Between Different Grating Slants

In some embodiments, different switchable gratings may include different initial alignment vectors which may produce different results. When the switchable grating is switched on, the gratings may include alignment vectors which are parallel to the extending direction of the grating and the waveguide. For example, in the case of an unslanted grating, the unslanted grating may have a K-vector which is parallel to the extending direction of the grating and the waveguide. In some embodiments, when the switchable grating is switched off, the alignment vectors may be oriented at an angle θ with respect to the switched on orientation. In some embodiments, the angle θ may be 34° or 56°. The K-vector of the grating is perpendicular to the orientation of the grating. The refractive index of the grating may be calculated by assuming that the grating is equivalent to a uniaxial birefringent crystal with extraordinary and ordinary axes nₑ and nₒ using the Equation 1:

$$n = \frac{{n}_{e} {n}_{o}}{\sqrt{{n}_{o}^{2} {sin}^{2} θ + {n}_{e}^{2} {cos}^{2} θ}} \qquad ( 1 )$$

In some embodiments, nₑ=1.61 and nₒ=1.52. Hence using Equation 1 for θ=56°, n may be 1.58. To calculate Δnₘᵢₙ, Δnₒₙ=n-nₒ=0.06. In this instance, the grating is switched on. To calculate Δnₘₐₓ, Δnₒₙ=nₑ-n=0.09. For θ=124°, Δnₘₐₓ=0.06 (switched on) and Δnₘᵢₙ=0.012 (switched off). The angle of the nₑ between switched and unswitched states may be only 34°. This leads to a small change in modulation between switched and unswitched states. The despeckler grating may thus be less effective than it would be if the change in the diffraction efficiency was large between the switched and unswitched states.

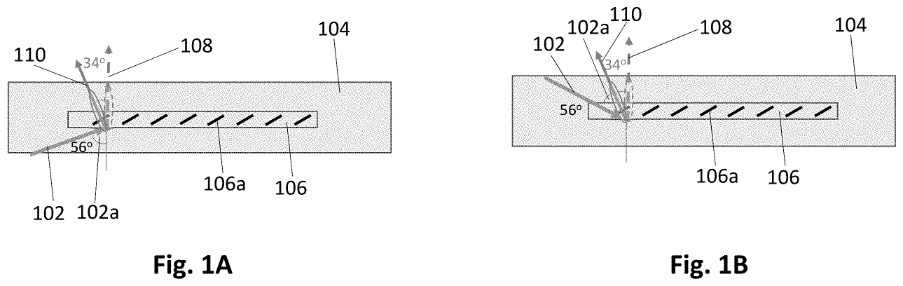

FIGS. 1A and 1B illustrate a conceptual schematic for a waveguide including a despeckler grating 106. The despeckler grating 106 may be embedded within the waveguide 104 such that light 102 in TIR is incident on the despeckler grating 106. The despeckler grating 106 may include diffracting fringes 106a. The extending direction of the despeckler grating 106 may be parallel with the extending direction of the waveguide 104. The despeckler grating 106 is a switchable grating such that when the switchable grating is switched on, the alignment vectors of the fringes 106a are oriented perpendicular to the extending direction of the grating 106 and the waveguide 104 such that the alignment vector 108 is oriented perpendicular to the extending direction of the grating 106 and the waveguide 104. In many embodiments, the alignment vector can be the extraordinary axis (ne) of the LC which, as discussed above, is parallel to the grating K-vector in the absence of a voltage normal to the reflecting surfaces of the waveguide. When the despeckler grating 106 is switched off, the alignment vector of the fringes 106a realign along a direction 110 which is parallel to the grating K-vector and are angularly offset from the alignment vector direction 108 that results when the grating 106 is switched on. In some embodiments, the alignment vector 110 may be slanted from the on alignment vector 108 at an angle of 34°. FIG. 1A illustrates upward-propagating incident light 102 subtending an angle of 56° with respect to the waveguide reflecting surfaces. FIG. 1B illustrate downward-propagating incident light 102 subtending an angle of 56° with respect to the reflecting surfaces of the waveguide 104.

In some embodiments, the grating fringes have slant angles oriented such that the angle between the alignment vectors of switched and unswitched states may be higher. In some embodiments, the orientation of the fringes of the grating in the unswitched state may be such that the alignment vector is parallel to the direction of incident TIR light. In some embodiment, the alignment vector of the grating in the unswitched state may be 56° to the waveguide surface normal which may be equal to the angle to the waveguide normal of incident light. In this case the despeckler grating may be slanted to align the grating K-vector with the incident upward TIR ray. This minimizes the diffraction efficiency (DE) experienced for the upward-going ray (at 56°). The TIR downward-going ray which is not normal to the grating fringe may include a lower difference in switched vs unswitched DE. In some embodiments, the incident upward TIR ray may include a refractive index difference Δnₘᵢₙ=0 when the grating is unswitched (switched off) and a refractive index difference Δnₘₐₓ=0.06 when the grating is switched on. In some embodiments, the incident downward-going TIR ray may include a Δnₘᵢₙ=0.06 when the grating is switched on and a Δnₘₐₓ=0.09 when the grating is only partially switched on.

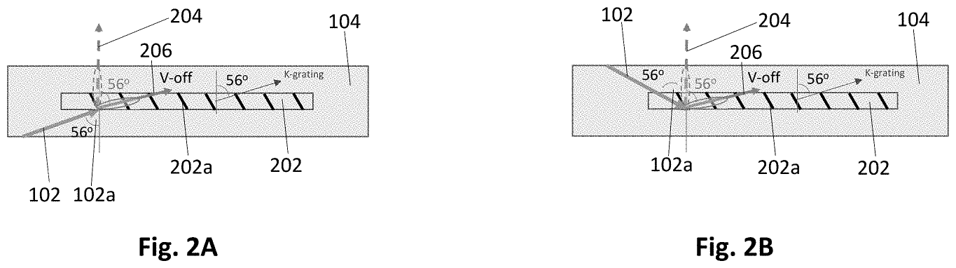

FIGS. 2A and 2B illustrate a conceptual schematic for a waveguide including a despeckler grating with a certain orientation in accordance with an embodiment of the invention. The waveguide 104 includes a despeckler grating 202 which includes slanted grating fringes 202a. The despeckler grating 202 may be a switchable grating such that when it is switched off, the despeckler grating 202 may include an alignment vector which is parallel to upward-propagating TIR light 102. In some embodiments, the alignment vector and the TIR light direction 102 may both be at 56° to the waveguide surface normal. FIG. 2A illustrates the TIR light 102 approaching the despeckler grating 202 from the bottom of the waveguide whereas FIG. 2B illustrates the TIR light 102 approaching the despeckler grating 202 from the top of the waveguide. As illustrated, when the switchable grating is switched off, the despeckler grating 202 includes an alignment vector which is parallel to the TIR light 102 approaching from the bottom of the waveguide. When the despeckler grating 202 is switched on, the orientation of the fringes 202a is such that the alignment vector 204 is perpendicular to both the extending direction of the grating 202 and the extending direction of the waveguide 104.

In some embodiments, the fringes of the gratings may be oriented such that the alignment vectors of the switched and unswitched states are perpendicular to each other. The component of the nₑ axis experienced by a p-polarized E field of the upwards and downwards rays may be identical. In some embodiments, with the incident upward-propagating TIR ray, the minimum index difference is Δnₘᵢₙ=0 with the grating partially switched on and the maximum index difference Δnₘₐₓ=0.06 with the grating fully switched on. In some embodiments, with the incident downward TIR ray, Δnₘᵢₙ=0.026 with the grating switched off and Δnₘₐₓ=0.09 with the grating partially switched on. Thus, a change in modulation between switched state (Δnₘᵢₙ=0.026) and unswitched state (Δnₘₐₓ=0.06) may be ΔΔn=0.034 for a typical RMLCM formulation. It is noted that interim modulations may be experienced as the LC molecules physically rotate during switching. Some additional values for partial switch states may also be possible.

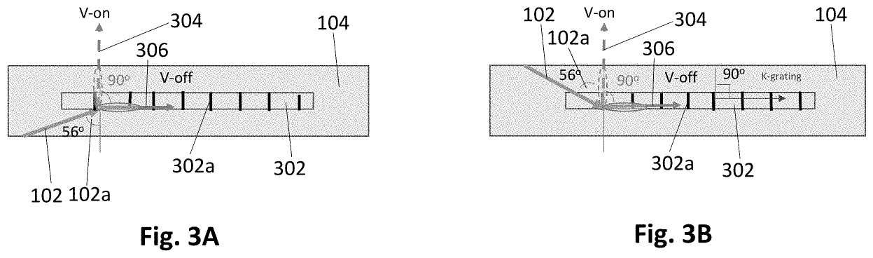

FIGS. 3A and 3B illustrate a conceptual schematic for a waveguide including a despeckler grating with a certain orientation in accordance with an embodiment of the invention. The waveguide 104 includes a despeckler grating 302 which includes unslanted fringes 302a. The despeckler grating 302 may be a switchable grating such that the alignment vector 306 of the grating 302 when switched off is perpendicular to the alignment vector 304 of the grating 302 when switched on. The alignment vector may be parallel to the grating K-vector when switched off and perpendicular to the grating K-vector when switched on.

### Embodiments Including Switchable Raman-Nath Gratings

The despeckler grating 106, 202, 302 of FIGS. 1-3 may be a switchable Raman-Nath grating. The switchable Raman-Nath grating may operate in a reverse mode. A reverse mode may be defined as a switchable grating which includes a non-diffractive mode as the unswitched passivate state where no electric field is provided and a diffractive mode as the switched active state where an electric field is provided. The electric field may be provided by a voltage source. In some embodiments, the electrodes of the voltage source create vertical electric field where the electrodes sandwich the switchable grating. In some embodiments, the electrodes of the voltage source create a horizontal electric field where the electrodes are positioned side by side in an in plane position. In some embodiments, a partial voltage may be provided to the switchable grating which only partially switches the grating to a certain angle.

A Raman-Nath grating is a grating which primarily relies on the Raman-Nath diffraction. Raman-Nath gratings are dissimilar to Bragg gratings which primarily rely on Bragg diffraction. A grating may satisfy any one of the conditions to be discussed below with reference to Equations 2-6 may be considered a Raman-Nath grating which relies primarily on Raman-Nath diffraction. Advantageously, Raman-Nath gratings may be less angularly dependent than Bragg gratings which may be useful in applications where light is not always coming in a single direction (e.g., in the concept discussed above in the despeckler grating 106, 202, 302 of FIGS. 1-3). While Raman-Nath gratings are discussed in connection with despeckler gratings, these are merely examples and it is contemplated that there are a wide range of application for switchable Raman-Nath gratings. In some embodiments Raman-Nath gratings may include chirped grating fringes. In some embodiments, Raman-Nath gratings may be utilized as multiplexed gratings. In some embodiments, Raman-Nath gratings may be utilized for scanning or sensors. Raman-Nath gratings may provide a wider angular range than Bragg gratings and conventional thin surface relief gratings.

In some embodiments, the switchable Raman-Nath grating may include a switchable grating formed from a material system including at least one monomer and at least one liquid crystal. The switchable grating may be formed through holographic exposure. In some embodiments, the switchable Raman-Nath grating may include an alignment layer to align the liquid crystal.

A Raman Nath grating may be considered a grating which satisfies Equation 2:

$$Q = \frac{2 πλ d}{{Λ}^{2} {n}_{0}} \leq 1 \qquad ( 2 )$$

Where λ is the incident light wavelength in vacuum, n₀ is the refractive index of the holographic medium, ∧ is the grating period, d is the thickness of the grating. According to the above definition, a grating is in the Raman Nath regime when Q≤1, and in the Bragg regime when Q≥10. In the intermediate region, Q is between 1 and 10 the grating regime may be influenced by the modulation, with the Q-value separation between the two regimes increases as the modulation increases. Equation 2 and alternative criteria to be discussed below are based on coupled wave theory. The theoretical background including a review of the key assumptions underlying the above equations is discussed in the paper T. K. Gaylord and M. G. Moharam, “Thin and thick gratings”, Applied Optics, Vol. 20, pages 3271-3273, Oct. 1, 1981 which is hereby incorporated by reference in its entirety. In the intermediate region, the grating regime may be determined using rigorous planar grating diffraction theory.

In some embodiments, the wavelength λ may be 0.52 μm, the grating thickness d may be 3 μm, the grating period ∧ may be 12.21481 μm, the average index \sqrt{∈₀} may be 1.568, the incident angle θ in grating may be 56°. These specifications lead to a Q′ of 0.074924 which is well below the qualifications for the Raman-Nath grating. Other configurations have been contemplated which satisfy Equation 2 and thus make the despeckler grating a Raman Nath grating.

An alternative equation for determining whether a grating is in the Raman-Nath regime incudes the grating strength defined according to the Kogelnik theory by Equation 3:

$$γ = \frac{π {ɛ}_{1} d}{2 λ \sqrt{{ɛ}_{0}}} \qquad ( 3 )$$

where θ is the incidence angle of the incoming wave in the grating, ε₁ is the relative permittivity modulation of the grating and ε₀ is the permittivity of vacuum.

The Q factor may be modified by Equation 4:

$${Q}^{′} = \frac{Q}{cos ( θ )} \qquad ( 4 )$$

Using the above formulas, the Raman-Nath regime may be entered when Q′γ≤1 and/or when Q′≤1.

Another criterion that can be used to determine whether a grating is in the Bragg regime employs the Nath parameter which is defined as Equation 5 for P polarized light:

$$ρ = \frac{2 {λ}^{2}}{{ɛ}_{1} {Λ}^{2}} = \frac{{λ}^{2}}{{n}_{0} {n}_{1} {Λ}^{2}} \qquad ( 5 )$$

The Nath parameter is defined as Equation 6 for S polarized light

$$ρ = \frac{2 {λ}^{2}}{{ɛ}_{1} {Λ}^{2} cos ( 2 θ )} = \frac{{λ}^{2}}{{n}_{0} {n}_{1} {Λ}^{2} cos ( 2 θ )} \qquad ( 6 )$$

where n₁ is the refractive index modulation, ε₁ is relative permittivity modulation, and n₁ is index modulation being related by

$${n}_{1} = \frac{{ɛ}_{1}}{2 {n}_{0}} .$$

The criterion for a Bragg grating in terms of the Nath parameter is ρ≥10. Alternatively, this condition may be stated as

$$\frac{1}{{ρ}^{2}} \leq 1 \% .$$

Whereas, the criterion for a Raman-Nath grating is ρ≤1.

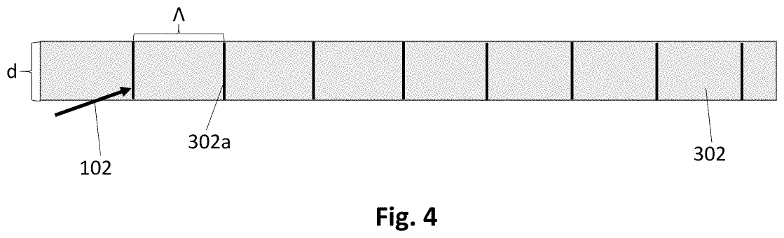

FIG. 4 illustrates a schematic of the grating 302 of FIGS. 3A and 3B. As illustrated, the grating 302 may include evenly spaced fringes 302a. The spacing of the fringes may make up a grating period ∧. The grating 302 may include a uniform thickness d. An incident light 102 may interact with the fringes 302a of the grating 302. The fringes 302a may be slanted with respect to an major axis (e.g. the extending direction) of grating 302. The incident light may have a certain wavelength λ₀. The grating 302 may have a certain average index n₀. The grating 302 may be an array of separately switchable elements such that each of the fringes 302a are separately switchable.

With regard to any criteria discussed above, a Raman Nath grating can be configured to operate over the visible band (e.g. over the wavelength range between about 400 nm to about 700 nm) or the infrared band (e.g. over the wavelength range between about 750 nm to about 2000 nm). In many applications a near infrared Raman-Nath grating may operate around the wavelength 1550 nm to provide eye safe infrared irradiation of the human eye.

As discussed above, the Raman-Nath regime does not necessarily require a thin grating in all applications. However, in many practical waveguide displays applications, a Raman-Nath grating can be thin, typically with a grating thickness d from 0.5 to 3 micron.

With regard to any of the criteria discussed above, the spatial modulation of the refractive index along a grating length x may be calculated through Equation 7:

n(x)=n₀+n₁ cos(\vec{K}*\vec{x}) (7)

Where \vec{K} is the grating vector (K-vector) which has a modulus

$$\frac{2 π}{Λ}$$

and \vec{x} is the unit vector along the x direction.

The index modulation can be controlled by the holographic material composition and will depend on the application. In some holographic photopolymers, modulations up to around 0.05 are typical. In HPDLC material systems, index modulations can vary from around 0.03 up to around 0.2 the latter being set by the birefringence of the LC component of the material system. Gratings for coupling into waveguides typically benefit from the higher modulation values, while extraction gratings which are required to be lossy may cover the maximum modulation range to provide uniform extraction.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A waveguide device comprising:
a waveguide;
a light source;
a coupler for directing light from the light source into a total internal reflection path within the waveguide;
a switchable Raman-Nath grating supported by the waveguide operative to provide a first polarization direction sensitivity under a first voltage and a second polarization direction sensitivity under a second voltage; and
a voltage generator for applying the first voltage or the second voltage across the switchable Raman-Nath grating,
wherein the switchable Raman-Nath grating receives light from the light in the total internal reflection path.

2. The waveguide device of claim 1, wherein the switchable Raman-Nath grating comprises fringes slanted with respect to an extending direction of waveguide.

3. The waveguide device of claim 1, wherein the switchable Raman-Nath grating is a despeckler grating.

4. The waveguide device of claim 1, wherein the switchable Raman-Nath grating comprises an array of separately switchable elements.

5. The waveguide device of claim 1, wherein the switchable Raman-Nath grating comprises a Q which satisfies the following equation:
$$Q = \frac{2 πλ d}{{n}_{0} {Λ}^{2}} \leq 1 ,$$
and
wherein d is the thickness of the switchable Raman-Nath grating, ∧ is the switchable Raman-Nath grating period, n₀ is the average refractive index of the switchable Raman-Nath grating, and λ is the wavelength of the light in the total internal reflection path incident on the switchable Raman-Nath grating.

6. The waveguide device of claim 5, wherein the thickness d of the switchable Raman-Nath grating is between 0.5 to 3 microns.

7. The waveguide device of claim 5, wherein λ is between 400 nm to 700 nm.

8. The waveguide device of claim 5, wherein λ is between 750 nm to 2000 nm.

9. The waveguide device of claim 5, wherein the switchable Raman-Nath grating comprises a Q′ which satisfies the following equation:
$${Q}^{′} = \frac{Q}{cos ( θ )} \leq 1 ,$$
and
wherein θ is the incidence angle of the light in the total internal reflection path incident on the switchable Raman-Nath grating.

10. The waveguide device of claim 1, wherein the switchable Raman-Nath grating comprises chirped grating fringes.

11. The waveguide device of claim 1, wherein the switchable Raman-Nath grating comprises a multiplexed grating.

12. The waveguide device of claim 1, wherein the switchable Raman-Nath grating comprises slanted grating fringes and the waveguide further comprises an alignment layer.

13. The waveguide device of claim 1, wherein the waveguide device provides input illumination to a waveguide display.

14. The waveguide device of claim 1, wherein the waveguide devices is configured to illuminate a reflection flat panel display and to provide a transmission path for light reflected from the reflection flat panel display.

15. The waveguide device of claim 1, wherein the switchable Raman-Nath grating comprises a switchable grating formed from a material system comprising at least one monomer and at least one liquid crystal and provides an extraordinary refractive index axis parallel to the grating K-vector.

16. The waveguide device of claim 1, wherein the switchable Raman-Nath grating comprises a reverse mode switchable grating.

17. The waveguide device of claim 1, wherein the switchable Raman-Nath grating is switchable such that the angle between the K-vector of the unswitched Raman-Nath grating and the K-vector of the switched Raman-Nath grating is between 34° to 90°.
